(19) United States
(12) Patent Application Publication
(10) Pub. No.: US 2007/0003814 A1
(43) Pub. Date: Jan. 4, 2007

(54) Polymer electrolyte membrane fuel cell stack

(76) Inventors: Allison M. Fisher, Chandler, AZ (US); Jerald A. Hallmark, Gilbert, AZ (US); Stephen R. Samms, Mesa, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/174,269

(22) Filed: Jun. 29, 2005

(51) Int. Cl. H01M 8/02; H01M 8/04

(52) U.S. Cl. 429/38; 429/26

(57) ABSTRACT

A polymer electrolyte membrane fuel cell stack (52) includes a plurality of membrane electrode assemblies (12) having evenly distributed fuel concentration across an anode (24), and efficient cooling across a cathode (26). A first plate (14) has a fuel side (28) with a plurality of serpentine channels (40) formed therein for distributing fuel across the anode (24), and a second plate (16) has an oxidant side (30) with oxidant channels (42) formed therein for distributing an oxidant across the cathode (26). The membrane electrode assembly (12) has an even fuel concentration thereacross, and the oxidant is routed through the cell (10) at least twice for absorbing heat prior to being distributed across the cathode (26).

### FIELD OF THE INVENTION

The present invention generally relates to fuel cells, and more particularly to a polymer electrolyte membrane fuel cell stack having improved fuel concentration across an anode, and efficient cooling across the cathode.

### BACKGROUND OF THE INVENTION

Fuel cells are electrochemical cells in which a free energy change resulting from a fuel oxidation reaction is converted into electrical energy. A typical fuel cell comprises a fuel electrode (anode) and an oxidant electrode (cathode) separated by an ion-conducting electrolyte. The electrodes are connected electrically to a load (such as an electronic circuit) by an external circuit conductor. In the circuit conductor, electric current is transported by the flow of electrons, whereas in the electrolyte it is transported by the flow of ions, such as the hydrogen ion (H⁺) in acid electrolytes, or the hydroxyl ion (OH⁻) in alkaline electrolytes. In theory, any substance capable of chemical oxidation that can be supplied continuously (as a gas or fluid) can be oxidized galvanically as the fuel at the anode of a fuel cell. Similarly, the oxidant can be any material that can be reduced at a sufficient rate. Gaseous hydrogen has become the fuel of choice for most applications, because of its high reactivity in the presence of suitable catalysts and because of its high power density. Similarly, at the fuel cell cathodes the most common oxidant is gaseous oxygen, which is readily and economically available from air for fuel cells used in terrestrial applications. When gaseous hydrogen and oxygen are used as fuel and oxidant, the electrodes are porous to permit the gas-electrolyte junction area to be as great as possible. The electrodes must be electronic conductors, and possess the appropriate reactivity to give significant reaction rates. At the anode, incoming hydrogen gas is oxidized to produce hydrogen ions (protons) and electrons. Since the electrolyte is a non-electronic conductor, the electrons flow away from the anode via an external electrical circuit. At the cathode, oxygen gas is reduced and reacts with the hydrogen ions migrating through the electrolyte and the incoming electrons from the external circuit to produce water as a byproduct. The byproduct water is typically expelled as vapor at elevated temperatures. The overall reaction that takes place in the fuel cell is the sum of the anode and cathode reactions, with part of the free energy of reaction released directly as electrical energy. The difference between this available free energy and the heat of reaction is produced as heat at the temperature of the fuel cell. It can be seen that as long as hydrogen and oxygen are supplied to the fuel cell, the flow of electric current will be sustained by electronic flow in the external circuit and ionic flow in the electrolyte.

In practice, a number of these unit fuel cells are normally stacked or ‘ganged’ together to form a fuel cell assembly. A number of individual cells are electrically connected in series by abutting the anode current collector of one cell with the cathode current collector of its nearest neighbor in the stack. Fuel and oxidant are introduced through manifolds into respective cells. The fuel and oxidant flow across the anode and cathode, respectively. One known fuel cell disclosed in U.S. Patent Publication 2004/0038112 A1 shows the fuel and oxidant flowing in serpentine channels across the anode and cathode. However, fuel is consumed as it progresses along the anode, creating an uneven fuel concentration and distribution of power across the anode. Furthermore, the oxidant tends to cool the cells it first contacts much more that the remainder of cells in the stack, causing uneven cooling of the fuel cell assembly resulting in uneven power distribution across the stack. Ideally, the temperature of the cells at the ends of the stack are the same as the cells in the center of the stack

Accordingly, it is desirable to provide a polymer electrolyte membrane fuel cell stack having evenly distributed fuel concentration from fuel flowing across an anode and improved heat distribution within the fuel cell stack. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A polymer electrolyte membrane fuel cell stack comprises a plurality of membrane electrode assemblies having evenly distributed fuel concentration across an anode, and efficient cooling from the oxidant that flows across a cathode. A first plate has a fuel side with a plurality of serpentine channels formed therein for distributing fuel across the anode, and a second plate has an oxidant side with oxidant channels formed therein for distributing an oxidant across the cathode. The membrane electrode assembly has an even fuel concentration thereacross and the oxidant is routed through the cell for absorbing heat prior to being distributed across the cathode.

### BRIEF DESCRIPTION OF THE DRAWINGS

The present invention will hereinafter be described in conjunction with the following drawing figures, wherein like numerals denote like elements, and

FIG. 1 is an exploded perspective view of a fuel cell in accordance with an exemplary embodiment of the present invention;

FIG. 2 is a cross sectional view of a portion of the fuel cell taken along the line 2-2 of FIG. 1;

FIG. 3 is a plane side view of a plate including fuel channels of the fuel cell of FIG. 1;

FIG. 4 is a plane side view of a plate including oxidant channels of the fuel cell of FIG. 1;

FIG. 5 is an exploded schematic side view of a stack of the fuel cells shown in FIG. 1;

FIG. 6 is a plane view of one backing plate of the fuel cell taken along the line 6-6 of FIG. 1; and

FIG. 7 is a plane view of the other backing plate of the fuel cell taken along the line 7-7 of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A polymer electrolyte membrane fuel cell is disclosed that operates at high temperature using membranes that don't require humidification to work. More specifically, the preferred embodiment of the present invention comprises a stack for operating elevated temperature (120-250° C.) polymer electrolyte membrane fuel cells that is compact and lightweight. Low and medium temperature polymer electrolyte membrane stacks (<120° C.) are complicated by water management and cooling issues. Water management is not an issue in polymer electrolyte membrane fuel cells operating at temperatures above 120° C., as long as the membrane is capable of proton conduction independent of humidity. Cooling issues are significantly different when using elevated temperature membrane electrode assemblies compared to “standard” Nafion-type membrane electrode assemblies. The problems that need to be resolved in an elevated temperature polymer electrolyte membrane fuel cell stack include: ensuring even fuel and thermal distribution across the stack, and sufficient thermal management such that operation at current densities <600 mA/cm² requires no additional stack-related “balance of plant” (other components required to cool or maintain the temperature in a fuel cell stack, e.g., fans, pumps, cooling channels, coolant fluid/gas, and control circuitry). Also, the stack should have very low pressure drop so that demand on system balance of plant is minimized, and also compact and lightweight to meet certain power density specs. In the stack disclosed herein, stack temperature is controlled by the rate, or stoichiometry, at which the cathode oxidant is supplied. During startup, or when the stack is operated at low load, cathode oxidant is supplied at rates corresponding to a fuel stoichiometry in the range of 1-3. During operation at higher temperatures/load, the rate of the oxidant flow is increased, which withdraws heat more quickly from the stack and reduces temperature. Typically, cathode oxidant flow rates corresponding to reactant stoichiometry 3-10 are sufficient to control the stack temperature when operating at the parameters anticipated for a portable power system. It is important for the temperature of the cells to be even across the length of the stack in order to ensure even power distribution, particularly when operating the stack using reformate fuel containing carbon monoxide impuritites. In practice, it is preferred that the temperature gradient along the length of the stack be less than 30° C. In the stack disclosed herein, the oxidant is passed through the edges of the stack assembly prior to passage across the cathode side of the fuel cell. This method has the advantage of preventing the ends of the stack from becoming excessively cooled during operation, and thus maintain an even stack temperature.

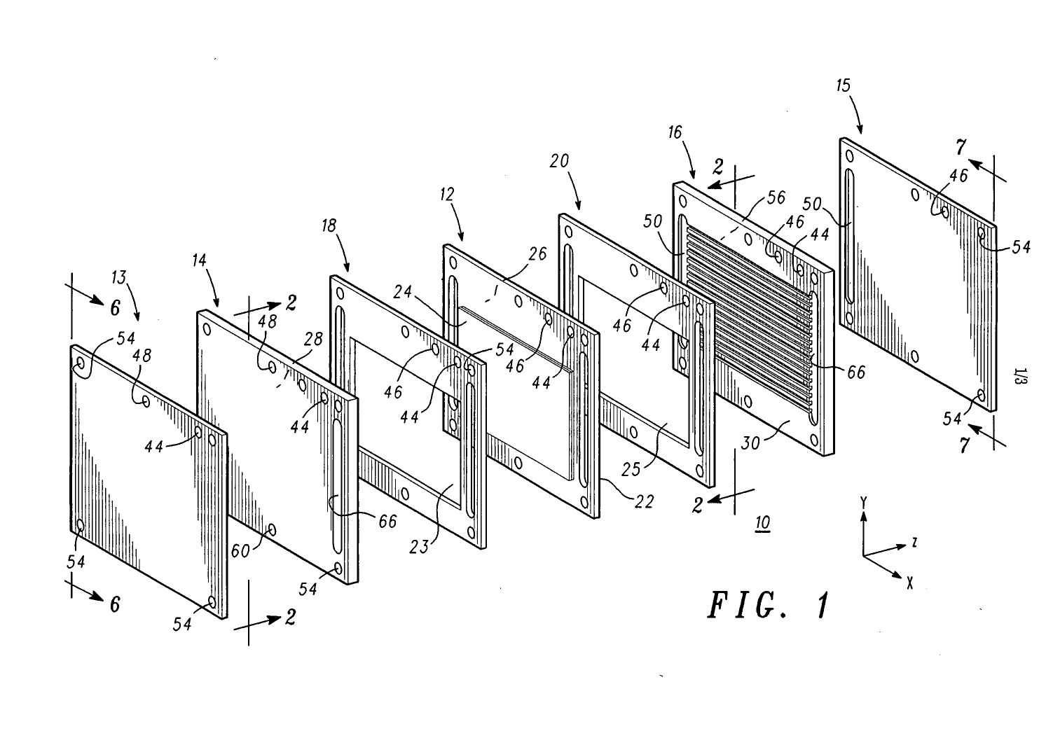

FIG. 1 is an exploded isometric view showing a single fuel cell 10 according to an exemplary embodiment of the present invention. The fuel cell 10 includes a membrane electrode assembly 12 separated from end plates 14, 16 by gaskets 18, 20, respectively. Gaskets 18, 20 seal gases between the membrane electrode assembly 12 and both the end plates 14, 16 within the fuel cell 10. The gaskets 18, 20 preferably comprise Teflon® materials such as Teflon coated fiberglass sheet, but may also comprise, for example, Viton® FEP (fluorinated ethylene propylene), and Nowoflon® PFA (perfluoroalkoxy). The end plates 14, 16 may comprise, for example, a metal.

The membrane electrode assembly 12 comprises an ion exchange membrane 22 of a solid polymer electrolyte interposed between an anode 24, and a cathode 26 on a side opposed to the anode 24. The ion exchange membrane 22 is any ionically conductive and not electron conductive material capable of operating up to 250° C. independent of external humidification, for example, Celtec® membrane electrode assembles from PEMEAS, Inc., preferably between 2 and 8 mils in thickness. The gasket 18 forms an opening 23 wherein the anode 24 is positioned against a side 28 of the end plate 14 and the gasket 20 forms an opening 25 wherein the cathode 26 is positioned against a side 30 of the end plate 16. The gasket preferably would have a thickness for which a sufficient compression and sealing is achieved.

Backing plate 13 is positioned adjacent to the end plate 14 and backing plate 15 is positioned adjacent the end plate 16 on opposed ends of the cell (or a stack of cells as described hereinafter). The backing plates 13, 15 have internal passages for the flow of fuel and an oxidant, respectively, as described hereinafter with reference to FIGS. 6 and 7. The oxidant preferably comprises air, but could be any gas containing sufficient oxidant for reacting with protons from the anode 24.

The backing plates 13, 15, end plates 14, 16, gaskets 18, 20, and ion exchange membrane 12 are held together, for example, by tightening bolts (not shown) inserted through holes 54 formed in opposed corners and secured by nuts (not shown).

Referring to FIG. 2, a cross section taken along the line 2-2 of FIG. 1 shows the anode 24 and cathode 26 each having a gas diffusion layer 32 and 34, respectively, comprising carbon cloth, non-woven fabric, or paper of typically between 14 and 16 mils in thickness (z direction), and each have an electrode catalyst layer 36 and 38, respectively comprising electrocatalysts such as platinum or alloys thereof, of between 10 and 20 microns in thickness (z direction). The material of the gas diffusion layer 32, 34 is laminated or pressed uniformly on the surface of the electrode catalyst layers 36, 38, respectively. The electrode catalyst layers 36, 38 are affixed to opposite sides of the ion exchange membrane 22. A plurality of fuel flow channels 40 and a plurality of air flow channels 42 are formed in the end plates 14 and 16, respectively, and are described subsequently in more detail.

FIG. 3 is a side view (the view is reversed from that of FIG. 1) of the side 28 of plate 14 that is positioned against the anode 24 of the ion exchange membrane 22. The fuel flow channels 40 comprise a plurality of grooves extending in a serpentine pattern that allows the fuel to flow back and forth across the anode 24 in both the x and y direction. The fuel enters the fuel flow channels 40 at a fuel inlet passage 44 and exits at a fuel outlet passage 46.

Referring to FIG. 2, the fuel diffuses into the gas diffusion layer 32 as it is distributed through the fuel flow channels 40. Also, the air diffuses into the gas diffusion layer 34 as it is distributed through the air flow channels 42. Protons from the fuel transverse the electrode catalyst layer 36, the ion exchange membrane 22, and the electrode catalyst layer 38 to the gas diffusion layer 34 in a manner known to those in the industry.

The ideal performance of a fuel cell is defined by its Nernst potential, E, or the ideal cell voltage. The overall reactions for a hydrogen fuel cell is as follows:
Anode: H₂→2H⁺+2e⁻
Cathode: ½O₂+2H⁺+2e⁻→H₂O
Overall Cell Reaction: H₂+½O₂→H₂O
Nernst Equation: E=E°+(RT/2F) In [P_{H2}/P_{H2O}]+(RT/2F) In [P₆₂]

At the anode, the reaction releases hydrogen ions (protons) and electrons whose transport is crucial to energy production. The protons build up on the anode creating a positive potential which promotes their transfer through the electrolyte (membrane) either by remaining connected through an attraction to a water or phosphoric acid molecule which travels through the electrolyte, or by transferring between water or phosphoric acid molecules. The oxygen side of the water molecule contains a slight negative charge which attracts the protons and may become attached to it, but the attraction is weak so any forces made are easily broken. The actual method of transfer varies depending on the type of electrolyte, but is based on the thickness of the membrane, the amount of water or phosphoric acid in the membrane, and the number of protons transported. Thus, the anode contains a net positive charge while the cathode, towards which the ions drift, contains a negative potential.

The acid functional groups in the electrolyte serve to provide structure for the electrolyte as well as a barrier to electrons. It is conducive for electrons to flow through materials whose electrons are held loosely (conductive materials) because of the process of electron transport. Thus, electrons move from the reactions sites on the anode through the gas diffusion section of the electrode, through the anode current collector, through a load to do work, across the cathode current collector, through the gas diffusion section of the electrode on the cathode and then to the catalyzed reaction sites on the cathode. The electrons do not move through the electrolyte because the acid chains hold their electrons tightly and thus constitute an electric insulator. Other criteria for selecting an electrolyte are its structural stability, low resistance to ionic movement and low porosity.

As the fuel is distributed and consumed through the fuel flow channels 40 (FIG. 3), the protons available for conduction to the cathode 26 decrease in number. Just after the fuel first enters the fuel flow channels 40 (at section 70), availability of fuel is as high as 95-100%, for example. After the fuel has flowed along the fuel flow channels 40, the fuel stream would be depleted to as low as 5% fuel availability as the fuel stream exits through the fuel outlet passage 46 (at section 72). By forming the serpentine fuel flow channels 40 in the manner shown in FIG. 3, an even distribution (concentration) of reactant (fuel) of about 50% is created across the anode. By positioning the fuel inlet passage 44 adjacent to the fuel outlet passage 46, the 100% and 5% proton availability averages out to about 50%. At section 74, the proton availability of the fuel would be about 75% while the fuel at section 76 would be about 25%, giving an average of about 50-55%. At section 78 the proton availability of the fuel would be about 50% while the fuel at section 80 would be about 50%, giving an average of 50%. The result is a more even distribution of fuel across the anode 24 than previously known.

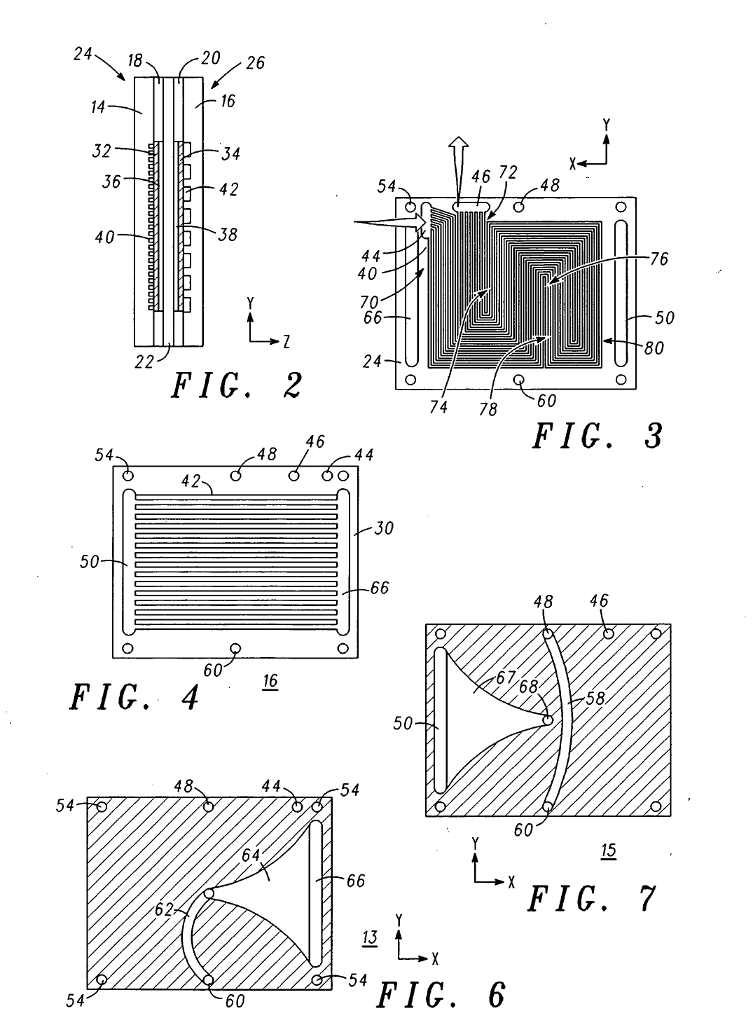

FIG. 4 is a side view of the side 30 of the end plate 16 that is positioned against the cathode 26 of the ion exchange membrane 22. The air flow channels 42 comprise a plurality of short grooves extending in a preferably parallel pattern for allowing oxidizing and cooling gas to flow across the cathode 26. The air enters the air flow channels 42 at an air inlet passage 66 and exits at a air outlet passage 50.

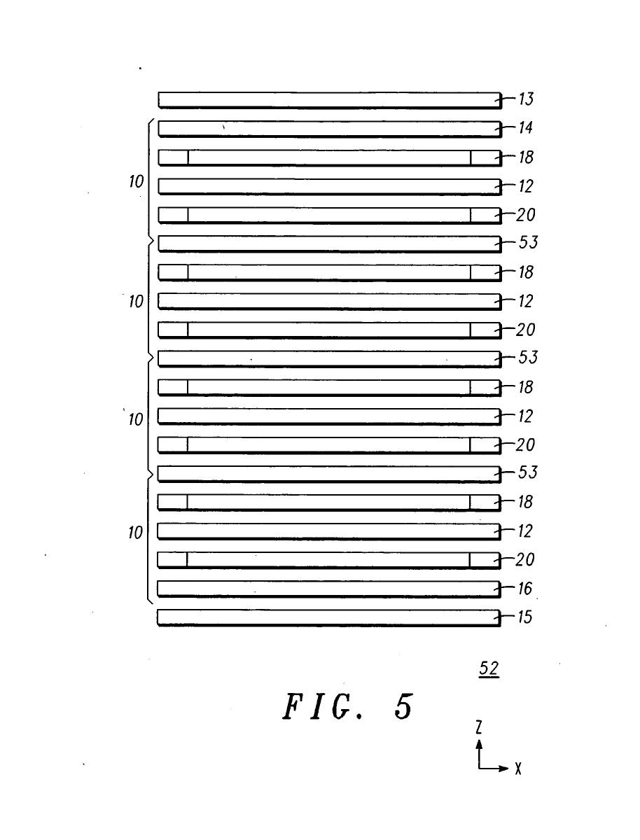

Referring to FIG. 5, a schematic block view illustrates a stack 52 of fuel cells 10 wherein, except for the cells 10 on the ends of the stack 52 (and more specifically end plates 14, 16), each cell 10 shares a bipolar plate 53 (positioned therebetween) with fuel being distributed on one side and an oxidizing gas being distributed on the other side. In this exemplary embodiment, the cell 10 on one end of the stack 52 has an end plate 14 for distributing fuel that is not shared with an adjacent cell 10 in the stack 52, and the cell 10 on the other end of the stack 52 has an end plate 16 for distributing the oxidizing gas that is not shared with an adjacent cell 10 in the stack 52.

A fuel, such as hydrogen, is fed into the fuel inlet passage 44 at the backing plate 13, traversing each of the cells 10 in the stack 52 through the fuel inlet passage 44 in the z direction. At end plate 14 and each bipolar plate 53, some of the fuel is diverted through fuel flow channels 40 to the fuel outlet passage 46 and out of the fuel cell stack 52 at the backing plate 15.

Referring to FIGS. 6 and 7, a cut away view taken along lines 6-6 and 7-7 of the backing plates 13, 15, respectively, are shown. The grooves 58, 62 and fan groove 64 are internal to the metal backing plates 13, 15. An oxidizing agent, such as air preferably, or any gas containing oxidant, is pumped into air inlet passage 48 in backing plate 13 and transverses the stack 52 in the z direction. When the air reaches the backing plate 15 (FIG. 7), the air migrates along groove 58 within the backing plate 15 to oxidation passage 60 and transverses the stack 52 in the −z direction. When the oxidizing agent reaches backing plate 13 again (FIG. 6), it migrates along groove 62 and is dispersed by fan grove 64 to air inlet passage 66. The oxidizing agent transverses the stack 52 through the air inlet passage 66 in the z direction. When the air reaches bipolar plates 52 and end plate 16, the oxidizing agent is dispersed through parallel grooves 42 across the cathode 26. After passing through groves 42, the air exits through air outlet passage 50 to fan groove 67 and out of the fuel cell 10 through air outlet passage 68.

The distribution of air through the air inlet passage 48 in the z direction and then back through the air passage 60 in the −z direction absorbs heat from the cells 10 of the stack 52. This both cools the stack 52 and preheats the air so the cells first exposed to the air are not cooled significantly more than the rest of the cells. By using the air to cool the stack 52 as well as for cathode oxidant, an additional cooling plate previously used in known fuel cells is avoided.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An elevated temperature fuel cell comprising:
a membrane electrode assembly including an anode and a cathode;
a first plate having a fuel side with a plurality of channels formed therein for distributing fuel across the anode; and
a second plate having an oxidant side with oxidant channels formed therein for distributing the oxidant across the cathode, the membrane electrode assembly having a substantially even fuel utilization thereacross.

2. The elevated temperature fuel cell of claim 1 wherein the plurality of serpentine channels comprises a plurality of sections positioned such that fuel utilization of adjacent sections produces about 55% average fuel concentration across the anode

3. The elevated temperature fuel cell of claim 1 wherein the plurality of serpentine channels have a common inlet and a common outlet positioned adjacent to one another, the serpentine channels having a plurality of sections being positioned such that the fuel concentration in adjacent channels averages about 55%.

4. The elevated temperature fuel cell of claim 1 wherein the elevated temperature fuel cell maintains a temperature gradient of less than 30° C.

5. The elevated temperature fuel cell of claim 1 wherein the membrane electrode assembly provides a proton conduction independent of humidity.

6. The elevated temperature fuel cell of claim 1 wherein the elevated temperature fuel cell is portable.

7. The elevated temperature fuel cell of claim 1 wherein the oxidant channels are parallel.

8. The elevated temperature fuel cell of claim 1 further comprising at least one oxidant passageway wherein the oxidant absorbs heat from the elevated temperature fuel cell prior to being distributed across the cathode.

9. The elevated temperature fuel cell of claim 1 wherein the oxidant passageway traverses the length of the elevated temperature fuel cell prior to being distributed across the cathode.

10. The elevated temperature fuel cell of claim 1 wherein the elevated temperature fuel cell operates at a temperature in the range of 120-250° C.

11. The elevated temperature fuel cell of claim 1 wherein the oxidant stoichiometry of the cathode is in the range of 1-10.

12. The elevated temperature fuel cell of claim 1 wherein the oxidant stoichiometry of the cathode is in the range of 2-5.

13. The elevated temperature fuel cell of claim 1 wherein the cathode comprises a low oxidant stoichiometry at startup, and a higher stoichimetry during operation.

14. A fuel cell comprising:
a membrane electrode assembly comprising:
an ion exchange membrane;
an anode comprising:
a first electrode catalyst layer; and
a first gas diffusion layer positioned between the first electrode catalyst layer and a first side of the ion exchange membrane; and
a cathode comprising:
a second electrode catalyst layer; and
a second gas diffusion layer positioned between the second electrode catalyst layer and a second side of the ion exchange membrane; and
a first plate having a fuel side with serpentine channels formed thereon for distributing fuel across the anode, the fuel having a substantially even concentration across the anode; and
a second plate having an oxidant side with channels formed therein for evenly distributing an oxidant across the cathode.

15. The fuel cell of claim 14 further comprising an oxidant passageway coupled to the second plate, the oxidant passageway traversing the fuel cell at least twice wherein the oxidant absorbs heat prior to being distributed across the cathode.

16. The fuel cell of claim 14 wherein the plurality of serpentine channels comprises a plurality of sections positioned such that fuel utilization of adjacent sections produces about 50% average fuel concentration across the anode.

17. The fuel cell of claim 14 wherein the fuel cell maintains a temperature gradient of less than 30° C.

18. The fuel cell of claim 14 wherein the fuel cell operates at a temperature in the range of 120-250° C.

19. A stack of fuel cells comprising:
a first fuel cell comprising:
a first membrane electrode assembly including a first anode and a first cathode; and
a first plate having a fuel side with serpentine channels formed therein for distributing fuel across the first anode;
a second plate having an air side with channels formed therein for evenly distributing air across the first cathode
a second fuel cell comprising:
a second membrane electrode assembly including a second anode and a second cathode;
a third plate having an air side with parallel channels formed therein for distributing air across the second cathode, and
wherein the second plate comprises serpentine channels formed on a second side opposed to the first side for distributing fuel having an even fuel concentration across the second anode.

20. The stack of fuel cells of claim 19 further comprising a plurality of fuel cells positioned between the first and second fuel cells, each of the plurality of fuel cells sharing a bipolar plate for distributing fuel and an oxidant with adjacent cells.

21. The stack of fuel cells of claim 19 comprising at least one air passageway wherein the air absorbs heat from the fuel cells prior to being distributed across the first and second cathodes.

22. The fuel cell of claim 19 wherein the oxidant passageway traverses the length of the fuel cell at least twice prior to being distributed across the cathode

23. The stack of fuel cells of claim 19 wherein the serpentine channels are formed so fuel utilization is substantially even from the fuel across the first and second anodes.
